(19) United States
(12) Patent Application Publication
(10) Pub. No.: US 2003/0122388 A1
(43) Pub. Date: Jul. 3, 2003

(54) Cooking utensil with conformal outer surface coating

(76) Inventor: Ricky K.C. Yeung, Hong Kong (HK)

Correspondence Address: MYERS BIGEL SIBLEY & SAJOVEC, PO BOX 37428, RALEIGH, NC, 27627, US

(21) Appl. No.: 10/289,143

(22) Filed: Nov. 6, 2002

(30) Foreign Application Priority Data
Nov. 7, 2001 (CN) 01266898.2

(51) Int. Cl. A47J 43/28

(52) U.S. Cl. 294/7

(57) ABSTRACT

According to some embodiments of the present invention, a cooking utensil comprises a rigid handle portion, a rigid head portion connected to the handle portion, and a soft and high temperature resistant plastic or silicon coating conforming to both the handle portion and head portion.

### RELATED APPLICATION

This application claims priority to Chinese Patent Application 01266898.2, filed on Nov. 7, 2001, the contents of which are herein incorporated by reference in their entirety.

### FIELD OF THE INVENTION

The present invention relates to cooking utensils such as a pancake turners, stirring rods, and the like, having a long handle portion with an end part gripped by the user and a head portion, such as a shovelhead.

### BACKGROUND OF THE INVENTION

Generally, a handle portion of a pancake turner is made of a rigid material, such as metal, and at least the end portion of the handle portion gripped by the user is made of a non-heat conductive material, such as wood or plastic. The head portion of the pancake turner is typically made of metal so that it has sufficient rigidity to turn over the food.

However, there is an increasing use of easily scraped non-stick coated pans. It is typically desirable that a user use a pancake turner with lower hardness than the non-stick layer, such as wood. However, germs or bacteria may quickly breed as a result of the wood absorbing water in use. An anti-germ plastic pancake turner can be obtained, but a soft plastic head typically cannot be easily mounted on a metal handle. A single-piece hard plastic pancake turner may be easily bent, which is generally undesirable.

Although a turner with a rigid handle portion can be made with a head that is non-harmful to the non-stick layer, there may be an exposed junction between the materials which can cause cleaning problems, water retention and germ growth.

### SUMMARY OF THE INVENTION

According some embodiments of the present invention, a cooking utensil can be provided with a desired rigidity that will not scratch to a pan surface, as well as a non-exposed conjunction, so that it may be easily cleaned and does not hide dirt. According to some embodiments, a coating of silicon plastic can increase comfort of the hand of the user.

According to some embodiments of the present invention, a cooking utensil comprises a rigid handle portion, a rigid head portion connected to the handle portion, and a soft and high temperature resistant coating, e.g., plastic or silicon, conforming to the handle portion and the head portion.

In some embodiments, the coating is less than 1 mm thick. The handle portion and the head portion may both be metal, and can comprise a single piece. The handle portion can be hollow. The head portion may have several parallel slots.

### BRIEF DESCRIPTION OF THE DRAWINGS

FIG. 1 is a perspective view of a cooking utensil according to first embodiments of the present invention.

FIG. 2 is a sectional view of the cooking utensil in FIG. 1.

FIG. 3 is a side view of a cooking utensil according to second embodiments of the present invention.

FIG. 4 is a sectional view of the cooking utensil in FIG. 3.

### DETAILED DESCRIPTION OF PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout. It will be understood that when an element such as a layer or region is referred to as being “on” another element, it can be directly on the other element or intervening elements may also be present. In contrast, when an element is referred to as being “directly on” another element, there are no intervening elements present.

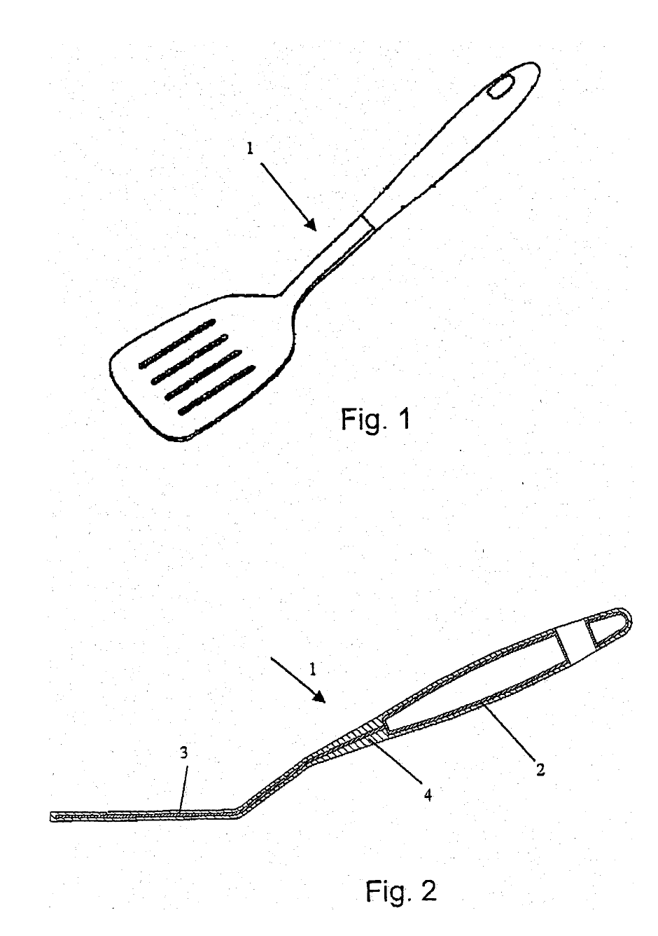

First embodiments of a cooking utensil according to the present invention are shown in FIGS. 1-2, which show a pancake turner 1. The pancake turner 1 has a hollow handle portion 2 and a metal head portion 3 connected to the handle portion. The head portion 3 is a shovel with a rectangular form, with four slots therein. The pancake turner 1 has a soft and high temperature resistant plastic or silicon coating 4 conforming to (in this case, completely covering) both the handle portion and the head portion to form a seamless cooking utensil, with the handle portion 2 and the head portion 3 formed as a core therein. In the illustrated embodiments, the coating 4 is less than 1 mm thick and the handle portion 2 and the head portion 3 are both metal and are formed in a single piece.

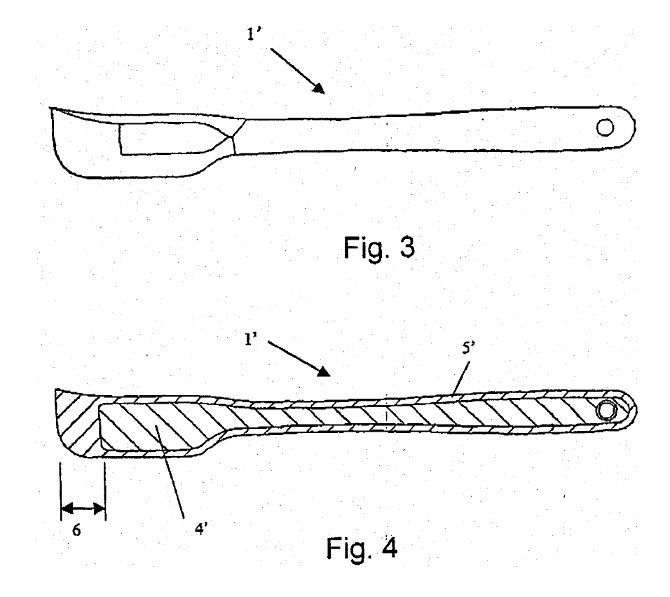

Second embodiments of a cooking utensil according to the present invention are shown in FIGS. 3-4, which illustrate a stirring stick 1′. The stirring stick 1′ has an integral core bar 5′ comprising a handle portion and a head portion, and a soft and high temperature resistant plastic or silicon coating 4′ completely covered the integral core bare 5′ to form a seamless one-piece surface. The tip of stirring stick 1′ is for stirring food and has tip area 6′ with extra soft and high temperature resistant plastic or silicon material so that tip area 6′ is flexible with larger motion angle tilted with pan in use.

Although a pancake turner and a stirring stick are shown, it will be understood that a cooking utensil according to various embodiments of the present invention may take other forms, such as a scoop, muddler, oil skimmer, etc. That is, the head portion can be modified in shape according to the different function such as circular, distort oval and with slot or hole therein. Cooking utensils according to present invention can be manufactured by so-called insert moulding or other methods.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A cooking utensil, comprising:
a rigid handle portion;
a rigid head portion connected to the handle portion; and
a soft and high temperature resistant coating conforming to both the handle portion and the head portion.

2. The cooking utensil as in claim 1, wherein the coating comprises plastic or silicon.

3. The cooking utensil as in claim 1, wherein the coating is less than 1 mm thick.

4. The cooking utensil as in claim 1, wherein the handle portion and the head portion comprise a single piece.

5. The cooking utensil as in claim 1, wherein the handle portion is hollow.

6. The cooking utensil as in claim 1, wherein the head portion has several parallel slots therein.

7. The cooking utensil as in claim 1, wherein the handle portion and the head portion are both metal.

8. The cooking utensil as in claim 1, wherein the head portion has a tip area comprising an extra soft and high temperature resistant plastic or silicon material.
